(19) United States
(12) Patent Application Publication
(10) Pub. No.: US 2026/0319708 A1
(43) Pub. Date: Oct. 15, 2026

(54) POST PACKAGING REPAIR IN MEMORY

(71) Applicant: Micron Technology, Inc., Boise, ID (US)

(72) Inventors: Wesley W. Borie, Boise, ID (US); Dennis G. Montierth, Boise, ID (US); Matthew D. Jenkinson, Boise, ID (US); Robert L. Buckingham, Boise, ID (US); Sujeet Ayyapureddi, Boise, ID (US)

(21) Appl. No.: 19/535,135

(22) Filed: Feb. 10, 2026

Related U.S. Application Data
(60) Provisional application No. 63/788,308, filed on Apr. 14, 2025.

(51) Int. Cl. G06F 3/06

(52) U.S. Cl. CPC G06F 3/0659; G06F 3/0604; G06F 3/0673

(57) ABSTRACT

Apparatuses and methods related to post packaging repair in memory. An example memory device can include a memory array coupled to control logic. The control logic receives memory device commands and includes command decode logic coupled to a mode register. Post-packaging repair (PPR) circuitry is coupled to the mode register and PPR tracking circuitry is coupled to the mode register and the PPR circuitry. A PPR fuse array is coupled to the PPR circuitry. The PPR fuse array includes a PPR tracking bit fuse array coupled to a PPR register and the PPR tracking circuitry. The control logic is configured to receive a command from the mode register to program the PPR fuse array. Input is received from the PPR tracking circuitry to identify whether the command to program the PPR fuse array has been executed. The command is executed based on the received input from the PPR tracking circuitry.

### PRIORITY INFORMATION

This application claims the benefit of U.S. Provisional Application 63/788,308, filed Apr. 14, 2025, which is incorporated by reference.

### TECHNICAL FIELD

The present disclosure relates generally to memory, and more particularly to apparatuses and methods associated with post-packaging repair in memory.

### BACKGROUND

Memory devices are typically provided as internal, semiconductor, integrated circuits in computers or other electronic devices. There are many different types of memory including volatile and non-volatile memory. Volatile memory can require power to maintain its data and includes random access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. including, but not limited to personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a portion of a computing system including a memory device in accordance with a number of embodiments of the present disclosure.

FIG. 2 is a block diagram of an apparatus in the form of a memory device including authentication fuses in accordance with a number of embodiments of the present disclosure.

FIG. 3 illustrates a portion of control logic as may be connected to a memory array and found in a memory device, such as control logic connected to memory array in memory device of FIG. 1, according to a number of embodiments of the present disclosure.

FIG. 4 illustrates an example of a portion of a state machine as may be included in hPPR/sPPR circuitry, such as hPPR/sPPR circuity shown in FIG. 3, according to numerous embodiments of the present disclosure.

FIG. 5 illustrates another example of a portion of a state machine as may be included in hPPR/sPPR circuitry, such as hPPR/sPPR circuity shown in FIG. 4, when a PPR fuse according to an hPPR sequence has not already been blown, or when a PPR latch according to an sPPR sequence has not already been set, according to numerous embodiments of the present disclosure.

FIG. 6 illustrates an example machine of a computer system within which a set of instructions, for causing the machine to perform various methodologies discussed herein, can be executed.

### DETAILED DESCRIPTION

The present disclosure includes apparatuses and methods related to post packaging repair (PPR) in memory. By way of example, various computing systems include a number of processing resources that are coupled to memory (e.g., a memory system), which is accessed in association with executing a set of instructions (e.g., a program, applications, etc.). Various component failure concerns surround memory systems, particularly post packaging in the field of use by customers. For example, redundant components may be built into memory systems to allow users to gain access to a memory system configuration and alter programmed states to facilitate repair to failed or inoperable components by substitution with redundant and/or replacement component features. In some instances, post packaging repair (PPR) command sequences may be initiated by users to blow PPR fuses to effectuate permanent changes (e.g., hard PPR (hPPR)) and substitute replacement components such as redundant (e.g., replacement) rows in memory devices. In other instances, PPR command sequences may be initiated by users to set latches to achieve reversible changes (e.g., soft PPR (sPPR) as temporary replacement components such as a redundant row in trouble shooting and diagnosing memory system issues. If PPR command sequences are not performed correctly greater issues and/or memory system failure may occur.

Accordingly, manufacture specification specific procedures are to be followed to ensure correct substitution and repair for operability. In order to correctly track repair measures taken and assess and/or analyze user repair attempts, tracking circuity to for log and record user repair initiatives are provided.

For example, tracking circuity may set registers in response to repair sequence tracking bits being triggered during a user attempted repair sequence. In one example, tracking circuitry may monitor hard and/or soft post packing repair circuitry on memory devices from a particular manufacturer and log initiation of commands received during in field use as activated by customer in order to validate whether a post packaging repair sequence was attempted and/or performed (e.g., executed) by a user can provide a level of assurance that the devices have not been replaced with devices from a different manufacturer, which may pose a security threat. Additionally, a manufacturer may want to ensure that a customer (e.g., an entity purchasing a memory system from a manufacturer/vendor) may want to ensure the customer employed the correct post packaging repair sequence as part of a return merchandise authorization (RMA) request. Often post packaging repair (PPR) specification information and records may be maintained (e.g., records retention) by high volume manufacturers (HVM) for a particular time period after manufacture of a memory system. However, it would be beneficial to maintain such PPR information and action data on the memory system itself for instances when an RMA is received outside of the HVM record retention time period. Without such PPR information it may prove costly and time consuming to validate and confirm or refute user PPR actions taken in the field of use in order to ascertain whether PPR sequences were attempted and/or performed correctly, particularly in association with RMA requests.

An example memory device can include a memory array coupled to control logic. The control logic receives memory device commands and includes command decode logic coupled to a mode register. Post-packaging repair (PPR) circuitry is coupled to the mode register and PPR tracking circuitry is coupled to the mode register and the PPR circuitry. A PPR fuse array is coupled to the PPR circuitry. The PPR fuse array includes a PPR tracking bit fuse array coupled to a PPR register and the PPR tracking circuitry. The control logic is configured to receive a command from the mode register to program the PPR fuse array. Input is received from the PPR tracking circuitry to identify whether the command to program the PPR fuse array has already been executed. And the command is executed based on the received input from the PPR tracking circuitry.

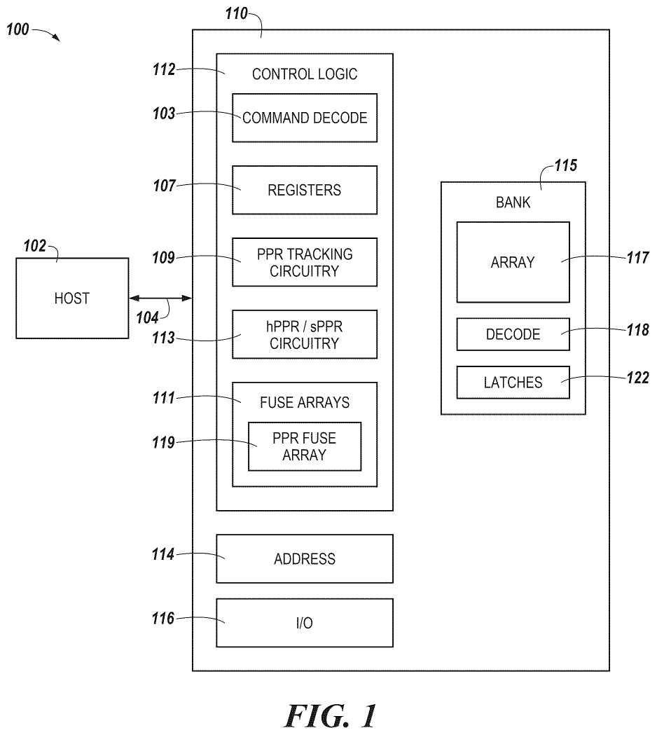

FIG. 1 is a block diagram of an apparatus in the form of a portion of a computing system including a memory device 110 in accordance with a number of embodiments of the present disclosure. In this example, the apparatus is a computing system 100 connected to a host 102 (e.g., processor) and the memory device 110. As used herein, a memory device 110, a memory bank 115, and/or memory controller 102, for example, might also be separately considered an “apparatus.”

In this example, computing system 100 includes a host 102 coupled to a memory device 110 via an interface 104. The memory device 110 can, for example, perform at least read operations and write operations in response to access requests from the host 102, which may include a personal laptop computer, a desktop computer, a digital camera, a mobile telephone, a memory card reader, or an Internet-of-Things (IoT) enabled device, among various other types of hosts. The host can access the memory device 110 in association with execution of an operating system (OS) and/or various applications.

The memory device 110 can be, for example, a DRAM device. Although a single memory device 110 is illustrated, embodiments are not so limited. For instance, the computing system 100 can include a plurality of memory devices 110 (e.g., DRAM dies) coupled to the host 102 as part of a memory module such as a dual in-line memory module (DIMM). The memory host 102 can access the one or more memory devices 110 via interface 104 responsive to host requests. As shown in this example, the memory device 110 includes address circuitry 114 to latch and decode address signals provided over the interface 104. The interface 104 can include, for example, a physical interface employing a suitable protocol (e.g., a data bus, an address bus, and a command bus, or a combined data/address/command bus). The memory device 110 includes input/output (I/O) circuitry 116 associated with transferring data to/from the memory device. The memory device 110 also includes control logic 112. The control logic 112 is configured to decode signals (e.g., commands) from the host 102, such as chip enable signals, write enable signals, and address latch signals that are used to control operations performed on the memory components 115 (e.g., memory banks), which can be referred to as memory components 115 and/or banks 115.

As shown in FIG. 1, the memory components 115 include an array 117 of memory cells, decode circuitry 118, and latches 122. The array 117 can be DRAM arrays, SRAM arrays, STT RAM arrays, PCRAM arrays, TRAM arrays, RRAM arrays, NAND flash arrays, and/or NOR flash arrays, for instance. The array 117 can comprise memory cells arranged in rows coupled by access lines (which may be referred to herein as word lines or select lines) and columns coupled by sense lines (which may be referred to herein as digit lines or data lines).

The decode circuitry 118 can include row and column decode circuitry configured to decode signals from the control logic 112 in association with accessing array 117. As described further below, the latches 122 of the memory banks 115 can latch signals received from the control logic 112. Such signals can include fuse information such as row address information, column address information, and/or configuration information broadcast to the bank 115.

In this example, the control logic 112 includes a command decoder 103, mode register (MR) 107, including post packaging repair (PPR) registers in association with PPR tracking circuitry 109 and hard and/or soft PPR (hPPR/sPPR) control circuitry 113, and arrays of programmable elements 111 (e.g., fuse arrays), including PPR fuse arrays 119. The control logic 112 is responsible for executing commands from the host 102. The control logic 112 and components listed above can comprise a state machine, a sequencer, and/or some other type of control circuitry, which may be implemented in the form of hardware, firmware, or software, or any combination of the three.

The command decoder 103 is configured to decode commands received from the host 102. The registers 107 can be, for example, “hidden” (e.g., reserved) mode registers (MR), which can only be written to internally (e.g., it cannot be written to via a command external to the memory device 110), e.g., guard sequence security. The registers 107 may also have a limited external read permission such that a particular sequence is required in order to read the contents via a command from a source external to the memory device 110. For example, the registers 107 can be read utilizing a read command and a reserved read address targeting the registers 107. The registers 107, including PPR registers in association with PPR tracking circuitry 109 and hPPR/sPPR circuitry 113, can store a PPR information used to log and/or authorize performance particular PPR sequences on the memory device 110, such as blowing a fuse, e.g., PPR fuse array 119, or setting a latch, etc., to substitute a redundant row for a faulty row in an array of memory, e.g., using the array of programmable elements 111. Although the array of programmable elements 111 is described as a fuse array, embodiments are not so limited. For example, the array of programmable elements may include various types of nonvolatile elements such as flash memory cells (e.g., NAND or NOR), phase change memory cells, etc. Additionally, as used herein, a fuse element is intended to include antifuse elements, and a fuse array 111 can include a number of fuses and/or a number of antifuses.

Although the examples provided herein are in the context of PPR repair, the fuse array 111 can be configured to store any type of code, e.g., additional tracking bit states. The use of repair information is provided as an example and is not intended to limit the type of codes (e.g., information that can be stored by the fuse array 111 and/or the type of tracking bit states, e.g., codes, that can be stored in the registers 107. Accordingly, the codes stored in the fuse array 111 can be used for purposes other than repair, e.g., to log action sequences associated with repair attempts.

As indicated above, a fuse array such as fuse arrays 111 can be used to store various information that can be used in association with the memory bank 115 for operating memory device 110. For example, fuse arrays 111 can include row fuses that can be used to remap defective rows (e.g., rows having defective memory cells) within bank 115 to redundant rows and column fuses that can be used to remap defective columns within bank 115. The fuse array can also include various option fuses that can store, for example, various configurations and/or trimming information. Some of the fuse information may be static, while other fuse information may be variable. As shown the fuse arrays 111 can include tracking bit states used to track actions performed and/or latches set, etc., in association with PPR. For example, in various instances, row address fuse data may be alterable via a post package repair (PPR) operation. A PPR operation refers to an operation used to remap defective memory addresses to redundant addresses after packaging of a memory device (e.g., when the memory device may only be accessible via contacts/pins). However, in various instances, a PPR operation only affects the row fuse data such that the column address fuse data is unaffected by a PPR operation (e.g., the column fuse data remains static).

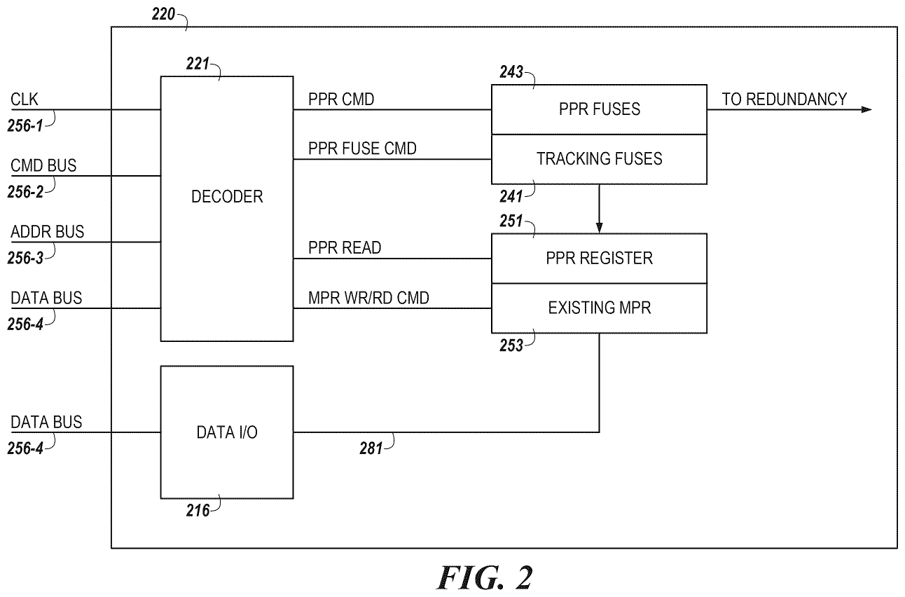

FIG. 2 is a block diagram of an apparatus in the form of memory device 220 including tracking bit fuses 241 in accordance with a number of embodiments of the present disclosure. The memory device 220 can be analogous to the memory device 110 in FIG. 1. The memory device 220 includes portions of a controller such as the control logic 112 in FIG. 1. The memory device 220 can be operated in accordance with a standard that supports PPR operations (e.g., JEDEC DDR4).

The memory device 220 includes the decoder 221, PPR fuses 243, tracking bit fuses 241, mode registers (MRs) including PPR registers 251 and existing MRs 253. The memory device 220 can also include data I/O circuitry 216 which is analogous to the I/O 116 of FIG. 1. The data I/O can couple the PPR registers 251 and the existing MRs 253 to the data bus 256-4.

The existing MRs 253 described in the DDR4 JEDEC, for example. PPR registers 251 describe tracking bit states that are set and read in tracking bit fuses 241.

The control circuitry can include a decoder 221 (e.g., command decoder). In various examples, the control circuitry may also include one or more of the PPR fuses 243 and/or the tracking bit fuses 241. In this example, the interface (e.g., 156 shown in FIG. 1) comprises a clock interface 256-1, a command bus 256-2, address bus 256-3, and a data bus 256-4. The device 220 can receive the PPR activation command and the repair tracking circuitry read command via the command bus 256-2. The device 220 can receive addresses via the address bus 256-1, and data can be provided to/from the device 220 via the data bus 256-4. The data bus 256-4 can provide data from the PPR tracking bit fuses 241 information to a host. The data read from the PPR tracking bit fuses 241 can be provided to the host to diagnose PPR activity on the memory device 220 via the data bus 256-4.

A host can provide, via the command bus 256-2, the PPR activation command to program the tracking bit fuses 241. The host can also provide, via the command bus 256-2, a PPR read command to read the PPR tracking bit fuses 241 via the PPR registers 251. The memory device 220 can receive the PPR activation command and the PPR read command at the decoder 221. The decoder 221 can decode the PPR activation command and/or the PPR read command.

The PPR activation command can be a mode register set (MRS) command. Responsive to receipt of the PPR activation command, the controller can set the PPR tracking bit fuses 241 and enter a PPR guard sequence (see FIG. 4). Setting the PPR tracking bit fuses 241 can include blowing a portion of the PPR tracking bit fuses 241 and leaving a portion of the tracking bit fuses 241 in their default state.

A PPR read command can also be received by the memory device 220. An address associated with the PPR read command can also be received by the memory device 220. The address can identify one or more MRs, including PPR registers 251. For example, the address can identify a particular PPR register 251. Responsive to determining that the PPR read command is received and that an address associated with the PPR read command corresponds to a PPR register 251, the controller can read the tracking bit fuses 241.

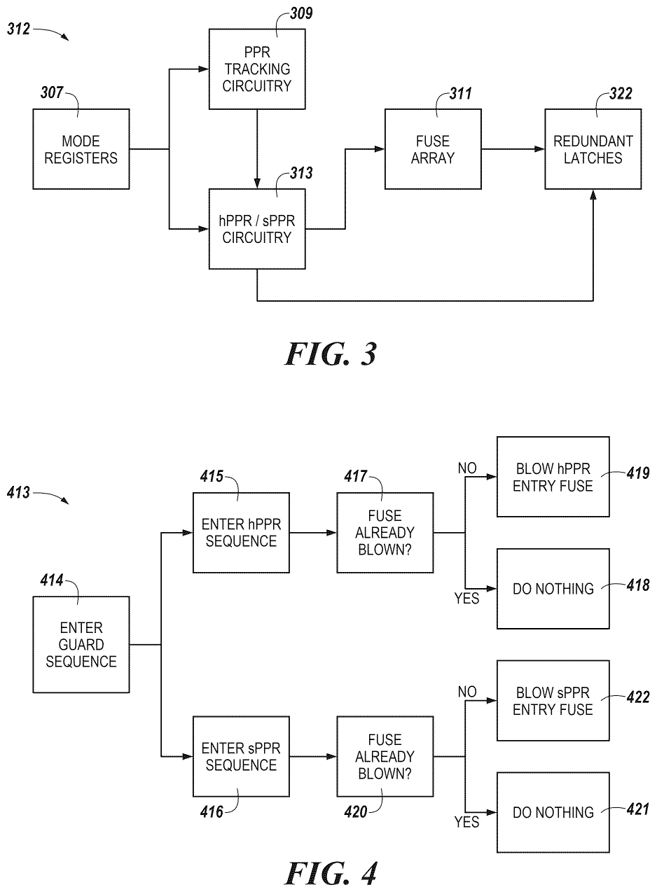

There can be a one-to-one relationship between the PPR register 251 and the tracking bit fuses 241. Each of the tracking bit fuses 241 can be associated with a different one of the PPR registers 251 as part of PPR tracking circuitry (see FIG. 3). Each of the PPR registers 251 can be configured to store a bit corresponding to an associated PPR fuse (hPPR) 243 and/or latch (sPPR). Storing bits, in the PPR registers 251, corresponding to the state of the tracking bit fuses 241 provides the ability to read the tracking bit fuse 241 through the PPR registers 251. In contrast, the PPR fuses 243 may not be read because there is no circuitry provided to couple the PPR fuses 243 to the data bus 256-4.

The PPR registers 251 can be read by moving the data from the PPR registers 251 to the data lines (DQs) 281 and from the DQs 281 to the data bus 256-4 via the data I/O 216. The PPR registers 251 can provide the data stored in the tracking bit fuses 241 via a single DQ and/or multiple DQs. For example, data can be moved from the PPR registers 251 to a DQ (e.g., DQ-0) such that all of the data is transmitted through the single DQ. The data can also be moved from the PPR registers 251 to the DQs such that a single instance of the data is transmitted utilizing each of the DQs. The data can further be moved from the PPR registers 251 to the DQs such that an instance of the data is transmitted through each of the DQs.

FIG. 2 also shows PPR commands and MR read and MR write commands. The PPR commands and MR read/write commands are shown to differentiate from the PPR activation commands and/or the PPR read commands. While both of the PPR fuses 243 and PPR tracking bit fuses 241 utilize fuse logic, each of the PPR fuses 243 and the PPR tracking bit fuses 241 can be programmed using different commands. While both PPR registers 251 and existing MRs 253 are implemented as MRs, the PPR registers 251 and the existing MRs 253 can be read utilizing different commands.

The existing MRs 253 can be written utilizing an MR write command. The PPR registers 251 can be written to in association with processing the PPR activation command and/or the PPR read command. For example, the PPR registers 251 can be written to responsive to programming the PPR tracking bit fuse 241. The programming of the tracking bit fuses 241 can result in setting (e.g., blowing) a portion of the tracking bit fuses 241 and retaining a default state of a different portion of the tracking bit fuses 241. After setting the portion of the tracking bit fuses 241, the data stored in the tracking bit fuses 241 can be read from the tracking bit fuses 241 and stored in the PPR registers 251.

The PPR registers 251 can also be written responsive to processing the PPR read command. For example, each time a PPR read command is received at the memory device 220, the data stored in the tracking bit fuses 241 can be read and moved to the PPR registers 251. In different examples, the data stored in the tracking bit fuses 241 can be stored in the PPR registers 251 a single time and thereafter the data can be read from the PPR registers 251 without transferring the data from the tracking bit fuses 241. Such examples can be utilized in instances where the tracking bit fuses 241 can only be programmed a single time, e.g., versus an sPPR latch setting.

FIG. 3 illustrates a portion of control logic as may be connected to a memory array and found in a memory device, such as control logic 112 connected to memory array 117 in memory device 110 of FIG. 1, according to a number of embodiments of the present disclosure. The control logic 312 is configured to receive memory device commands.

As described in connection with FIGS. 1 and 2, the control logic can include command decode logic, e.g., 103 in FIG. 1, and includes mode registers 307 coupled to command decode logic. In the example embodiment shown in FIG. 3, the mode registers 307 are connected to post-packaging repair (PPR) circuitry 313 (e.g., 113 in FIG. 1). According to embodiments, the mode registers 307 are additionally coupled to PPR tracking circuitry 309 (e.g., 109 in FIG. 1). The PPR circuitry 313 can include a hard (e.g., permanent) and soft (e.g., revisable) PPR circuitry (hPPR/sPPR, respectively). As shown in FIG. 3, the hPPR circuitry may be connected to a fuse array 311 and the sPPR may be connected to redundant latches 322. By way of example and not by way of limitation, as used herein the term redundant latches is intended to refer to a latch that may be set to substitute in a redundant row of memory for a defective and/or failed row of memory. As noted above, the PPR tracking circuitry 309 is connected to the PPR circuitry 313.

According to embodiments, the control logic 312 is configured to execute a received command and transfer a code from a mode register to the PPR circuitry 313 to program the memory cell access fuse array 111 and/or set redundant latches 322. For example, as shown in FIG. 4, the control logic 312 can decode and execute a received command and communicate instructions to the hPPR/sPPR circuitry to enter a guard sequence. If the guard sequence instructions are completed correctly, then instructions may be given by the PPR circuitry 313 to enter either an hPPR sequence or an sPPR sequence, depending on the command instructions received. The control logic 312 can further execute the command to transfer a code from a mode register 307 to the PPR tracking circuitry 309. The PPR tracking circuitry 309 may then additionally communicate instructions with the hPPR/sPPR circuitry 313 to identify if a fuse has already been blown in the hPPR sequence or a latch already in the sPPR sequence, as described in connection with FIG. 4. Thus, the hPPR/sPPR circuitry 313 can identify the command to program to the fuse array 311 or set a latch 322 upon direction from the PPR tracking circuitry 309 according to instructions received from the mode register responsive to receiving a particular code.

As described above, in one example the PPR circuitry 313 receives instructions to enter a hard PPR (hPPR) sequence. Hence code received to the PPR circuitry 313 enables hard post-package repair (hPPR). In this example, the PPR circuitry 313 may receive a PPR code designated as mode register (MR) MR23 OP[0]=1 to enter the hPPR sequence. The PPR circuitry 313 may then wait tMRD (time mode register delay) to receive input from the PPR tracking circuitry 309, e.g., that a fuse 311 has already been blown (see FIG. 4), to execute the command and perform the hPPR sequence.

In another example, the code received to the PPR circuitry 313 enables soft post-packaging repair (sPPR). In this example, the PPR circuitry 313 may receive a PPR code designated as mode register (MR) MR23 OP[2:1]=01 to enter the sPPR sequence. The PPR circuitry 313 may then wait tMRD to receive input from the PPR tracking circuitry 309, e.g., that a latch has already been set 322 (see FIG. 4), to execute the command and perform the sPPR sequence.

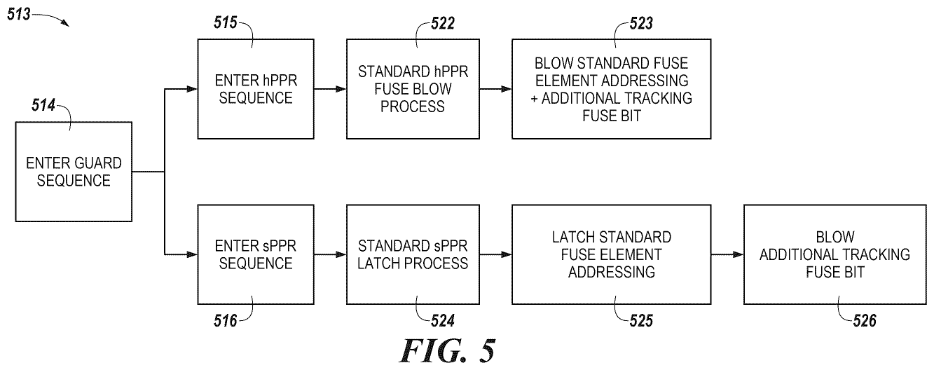

Hence, according to embodiments a memory device, e.g., 110 in FIG. 1, can include PPR tracking circuitry 309 which is configured to determine whether a fuse of the memory cell access fuse array 311 has been blown by either the hPPR or the sPPR circuitry. For example, control logic 312 can use the hPPR circuitry 313 to blow a fuse upon the PPR tracking circuitry 309 determining that a particular fuse of the memory cell access fuse array 311 has not already been blown. Further the PPR tracking circuity 309 can blow an associated tracking bit fuse, e.g., 241 in FIG. 2, and register this state information in an appropriate PPR register, e.g., 251 in FIG. 2, readable by the PPR tracking circuitry 309 for future operability, assessment, and analysis, such as in a return merchandise authorization (RMA) request. Similarly, control logic 312 can use sPPR circuitry 313 to latch a fuse element upon the PPR tracking circuitry 309 determining that the fuse element of the fuse array 311 has not already been latched. Further the PPR tracking circuitry 309 can blow an associated tracking bit fuse, e.g., 241 in FIG. 2, and register this state information in an appropriate PPR register, e.g., 251 in FIG. 2, readable by the PPR tracking circuitry 309 for future operability, assessment, and analysis, such as in a return merchandise authorization (RMA) request. Further discussion in connection with the same in provided in connection with FIG. 5.

FIG. 4 illustrates an example of a portion of a state machine as may be included in hPPR/sPPR circuitry 413, such as hPPR/sPPR circuity 313 shown in FIG. 3, according to numerous embodiments of the present disclosure. As shown in the example embodiment of FIG. 4, the hPPR/sPPR circuity may receive command instructions for a PPR and enter a guard sequence 414. If the received command completes the guard sequence 414, then the hPPR/sPPR circuity 313 in FIG. 3 may enter an hPPR sequence 415 or an sPPR sequence 416 depending on the command received and instructions handled by the hPPR/sPPR circuitry 313 in FIG. 3.

As shown in the example embodiment of FIG. 4, if the hPPR sequence 415 is entered the hPPR/sPPR circuitry 313 in FIG. 3 will receive input from the PPR tracking circuity 309 (also FIG. 3) to identify at 417 whether a fuse has already been blown. As shown at 418, if the fuse has already been blown, e.g., “YES”, the operation may cease and no further action conducted in the hPPR sequence. If however, as shown at 419, the fuse has not already been blown, e.g., “NO”, the operation may continue to blow an appropriate hPPR entry fuse.

Similarly, as shown in the example embodiment of FIG. 4, if the sPPR sequence 416 is entered the hPPR/sPPR circuitry 313 in FIG. 3 will receive input from the PPR tracking circuitry 309 (also shown in FIG. 3) to identify whether a reversable, e.g., temporary, latch has already been set, e.g., fuse already blown 420. As shown at 421, if the latch has already been set, e.g., “YES”, the operation may cease and no further action conducted in the sPPR sequence. If however, as shown at 422, the latch has not already been set, e.g., “NO”, the operation may continue to set an appropriate latch, e.g., blow an appropriate sPPR entry fuse.

According to embodiments, in an hPPR or sPPR repair sequence, e.g., 415 or 416 in FIG. 4, a PPR activation command can be verified utilizing a command identifier associated with PPR tracking circuitry 309 in FIG. 3. The command identifier can be provided as a signal or utilizing a plurality of signals. For example, the command identifier can be a plurality of sequential signals. The sequential signals can be comprised of one or more commands and a various number of commands can constitute a command sequence having the command identifier. For example, the command sequence can be comprised of four MR commands or a different quantity of MR commands. The order of the commands comprising the command sequence can be part of the command sequence. Each of the commands can be in a specific order to constitute the command sequence. Embodiments, however, are not limited to this example.

Based on determining that the correct command sequence was provided, the controller can generate and/or process and an activate command and/or a write command. In various instances, the activate command and/or the write command can be part of an hPPR or sPPR repair sequence and PPR fuse entry state, e.g., 415 or 416, and/or the PPR tracking fuse write state, 523 or 526 in FIG. 5, communicate to an appropriate PPR register 251 in FIG. 2 associated with PPR tracking circuitry 309 in FIG. 3. The PPR command can activate the PPR fuses when allowed by PPR tracking circuitry 309 in FIG. 3. The write command can program the PPR tracking fuses by setting a portion of the fuses (as described in connection with FIG. 5) and communicate to an appropriate PPR register 252 in FIG. 2 associated with PPR tracking circuitry 309 in FIG. 3.

As will be discussed more in connection with FIG. 5, in accordance with embodiments of the present disclosure the hPPR/sPPR circuity 313 can further follow the hPPR or SPPR sequence 515 or 516 to blow an appropriate additional tracking bit and register, e.g., record, this additional tracking bit state information in an appropriate register, e.g., PPR register 251 in FIG. 2, associated with PPR tracking circuitry 309 in FIG. 3.

FIG. 5 illustrates another example of a portion of a state machine as may be included in hPPR/sPPR circuitry 313 in FIG. 3, and/or hPPR/sPPR circuity 413 shown in FIG. 4. As shown in the embodiment of FIG. 5, when a PPR fuse according to an hPPR sequence 515 has not already been blown, e.g., 417/419 in FIG. 4, or when a PPR latch according to an sPPR sequence 416 has not already been set, e.g., 420/422, then as part of an hPPR or sPPR repair sequence the a respective hPPR fuse may be blown 522 or sPPR latch may be set 525 and additionally a tracking bit fuse blown 523 or 526, according to numerous embodiments of the present disclosure. As shown in the example embodiment of FIG. 5, the hPPR/sPPR circuity may receive command instructions for a PPR and enter a guard sequence. If the received command completes the guard sequence 514, then the PPR circuity 313 in FIG. 3, may enter an hPPR sequence 515 or an sPPR sequence 516 depending on the command received and instructions handled by the PPR circuitry 313 in FIG. 3. At 515 hPPR sequence has been entered and the hPPR fuse blow process commenced 522. If the PPR tracking circuitry 309 in FIG. 3 indicates that the PPR fuse has not already been blown at 417 in FIG. 4, then the sequence may continue to blow an addressed hPPR fuse 522 in FIG. 5. However, as shown in the example embodiment of FIG. 5, the hPPR sequence will further continue to blow an associated tracking fuse bit 523.

Similarly, the PPR circuity 313 in FIG. 3 may enter an sPPR sequence 516 depending on the command received and instructions handled by the PPR circuitry 313 in FIG. 3. At 516 an sPPR sequence has been entered and an sPPR latch process commenced 524. If the PPR tracking circuitry 309 in FIG. 3 indicates that the sPPR latch has not already been set at 420 in FIG. 4, then the sequence may continue to set an addressed sPPR latch 525 in FIG. 5. However, as shown in the example embodiment of FIG. 5, the sPPR sequence will further continue to blow an associated tracking fuse bit 526. As described above in connection with FIG. 3, in one example, the control logic can decode and execute a received command and communicate instructions to the hPPR/sPPR circuitry to enter a guard sequence. The hPPR/sPPR circuitry 513 can identify the command to program to the fuse array 522 or set a latch 525 upon direction from the PPR tracking circuitry, 309 in FIG. 3, according to instructions received from the mode register 307 responsive to receiving a particular code. Additionally associated tracking fuse bits will be set 523 and/or 526 and communicated to the PPR register 251 in FIG. 2.

Data from the PPR registers 251 in FIG. 2 can be provided to a host and/or an entity performing a return merchandise authorization or other authentication. For example, the data can be provided to a host internal to a computing device comprising the memory device or a host external to a computing device comprising the memory device. In an example, a plurality of memory devices can be authenticated utilizing a network. A host, through a network, can program a plurality of different PPR fuses corresponding to different memory devices by providing PPR program commands to the different memory devices. A host can additionally provide PPR read commands to the memory devices to read the PPR codes stored in the different PPR fuses (e.g., with set states representing one logical binary value (“1” or “0”) and stored in the authentication registers 251 in FIG. 2). The data corresponding to the PPR codes can be provided by the respective memory devices through a network to the host.

The command to read can be provided utilizing a mode register read command that comprises both the read command and the PPR register address. The mode register read command can be used to access a plurality of bits that are stored in a plurality of latches that comprise the register 251 in FIG. 2. Although a register is provided in the singular, a register can represent one or more registers and/or latches that store one or more bits of data. There can be a one-to-one relationship between the plurality of latches in a register 251 and a plurality of tracking bit fuses associated with the PPR tracking circuitry 309 and the PPR tracking fuse array.

In some examples, a comparison of what has been set in tracking bit fuses as attempted and/or executed PPR sequences versus what has been reported can be performed external to the memory device. In other examples, the comparison is performed internal to the memory device utilizing the external PPR code. The memory device may have errors if the attempted and/or executed PPR sequences do not coincide and/or evidence the correct and/or intended PPR sequences. In some examples, a host can perform the comparison.

Performing the comparison internal to the memory device can include receiving the external PPR code from a host. The external PPR code can be received by the memory device. The memory device can compare the external PPR code to the PPR code retrieved from the tracking bit fuses. The external PPR code can be stored in registers other than the PPR registers and/or the external PPR code can be stored in the PPR registers.

Based on the comparison performed internal to the memory device, the memory device can perform a number of actions. For example, the memory device can refrain from processing additional commands including read or write commands. The memory device can also report the results of the comparison. For example, the memory device can set a flag in a register. A host can refer to the flag to determine whether the memory device is in a failure state. The host can perform a number of actions based on the value of the flag including refraining from storing data in the memory device, among others.

The memory device can comprise the plurality of authentication fuses and a plurality of PPR fuses. The PPR fuses can be independent from the authentication fuses. The authentication fuses can be independent from the PPR fuses by utilizing different command sequences to program the authentication fuses and program the PPR fuses, by utilizing different fuses for the hPPR/sPPR repair fuses and the PPR tracking fuses, and/or for utilizing the other fuses for different purposes. For example, the PPR fuses are used to repair the memory array while the PPR tracking fuses are used to store data.

In some examples, the processing resource can execute an application which provides the instructions to compare a PPR code read from a register of a memory device to an externally provided PPR code. The application can be used to analyze PPR activity on the memory device. The application can provide the externally provided PPR code and verify the retrieved PPR code. In some examples, a first application can program the PPR tracking fuses and a different application can read the programmed, e.g., stored PPR tracking bit, fuse information from the registers 251 analyze a computing device.

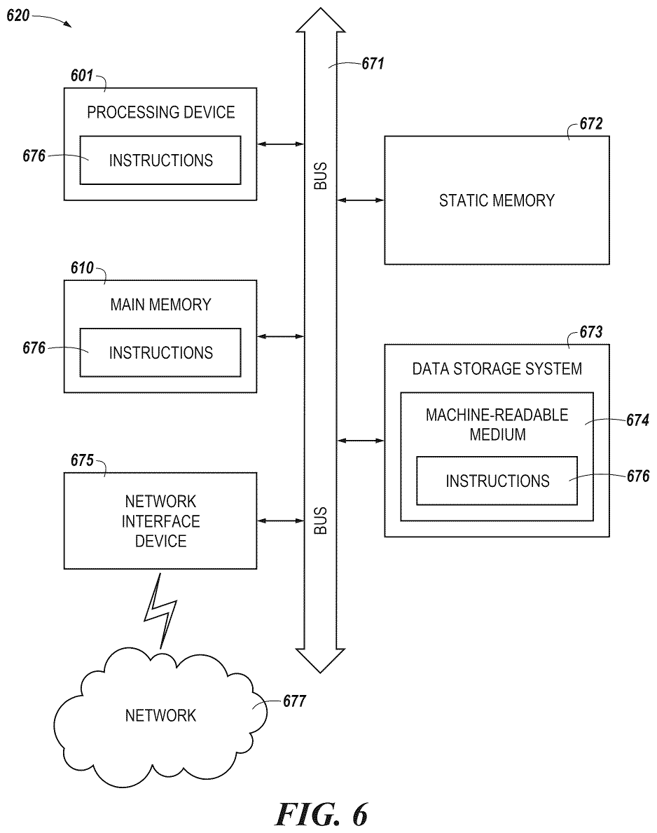

FIG. 6 illustrates an example networked system 620 within which circuitry, information, commands, and instructions, to perform various memory post packaging repair (PPR) methodologies with tracking as discussed herein, can be performed. In various embodiments, the networked system 620 can include a computing system that includes, is coupled to, or utilizes a memory system (e.g., the memory system 100 of FIG. 1). In alternative embodiments, the network system 620 can be connected (e.g., networked) to other networked systems in a LAN, an intranet, an extranet, and/or the Internet. The networked system 620 can operate in the capacity of a server or a client machine in client-server network environment, as a peer machine in a peer-to-peer (or distributed) network environment, or as a server or a client machine in a cloud computing infrastructure or environment.

The networked system can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine.

The example networked system 620 includes a processing device 601, a main memory 610 (e.g., read-only memory (ROM), flash memory, dynamic random access memory (DRAM) such as synchronous DRAM (SDRAM) or Rambus DRAM (RDRAM), etc.), a static memory 672 (e.g., flash memory, static random access memory (SRAM), etc.), and a data storage system 673, which can communicate with each other via a bus 671.

Processing device 601 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 601 can also be one or more special-purpose processing devices such as an application specific integrated circuit (ASIC), a field programmable gate array (FPGA), a digital signal processor (DSP), network processor, or the like. The processing device 601 is configured to execute instructions 676 for performing the operations and steps discussed herein. The networked system 620 can further include a network interface device 675 to communicate over a network 677.

The data storage system 673 can include a machine-readable storage medium 674 (also known as a computer-readable medium) on which is stored one or more sets of instructions 676 or software embodying any one or more of the methodologies or functions described herein. The instructions 676 can also reside, completely or at least partially, within the main memory 610 and/or within the processing device 601 during execution thereof by the system 620, the main memory 610 and the processing device 601 also constituting machine-readable storage media.

In a number of embodiments, the instructions can be in the form of circuitry 676 and include circuitry to implement post packaging repair (PPR) with tracking as described with the control logic 112 of FIG. 1. While the machine-readable storage medium 674 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

As used herein, “a number of” something can refer to one or more of such things. For example, a number of memory devices can refer to one or more memory devices. A “plurality” of something intends two or more. Additionally, designators such as “N,” as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A memory device, comprising:
a memory array;
control logic coupled to the memory array, the control logic to receive memory device commands, the control logic, comprising:
command decode logic;
a mode register coupled to the command decode logic;
post-packaging repair (PPR) circuitry coupled to the mode register; and
PPR tracking circuitry coupled to the mode register and the PPR circuitry; and
a PPR fuse array coupled to the PPR circuitry, the PPR fuse array including a PPR tracking bit fuse array coupled to a PPR register and the PPR tracking circuitry, wherein the control logic is configured to:
receive a command from the mode register to program the PPR fuse array;
receive input from the PPR tracking circuitry to identify whether the command to program the PPR fuse array has already been executed; and
execute the command based on the received input from the PPR tracking circuitry.

2. The memory device of claim 1, wherein the PPR circuitry includes both a hard PPR circuit (hPPR) and a soft PPR (sPPR) circuit.

3. The memory device of claim 1, wherein executing the command enables a hard PPR (hPPR) sequence in the PPR circuitry.

4. The memory device of claim 3, wherein the command is a mode register command and the PPR circuitry waits a time mode register delay (tMRD) to execute the command.

5. The memory device of claim 1, wherein executing the command enables a soft PPR (sPPR) sequence in the PPR circuitry.

6. The memory device of claim 5, wherein the command is a mode register command and the PPR circuitry waits a time mode register delay (tMRD) to execute the command.

7. The memory device of claim 2, wherein the PPR tracking circuitry is configured to determine whether a fuse of the PPR tracking bit fuse array has been blown by either a previous hPPR sequence or a previous sPPR sequence.

8. The memory device of claim 7, wherein executing the command further comprises:
causing the hPPR sequence to blow an associated fuse in the PPR fuse array if the received input from the PPR tracking circuitry determines that the associated fuse of the PPR fuse array has not been blown; and
blowing an associated tracking fuse bit readable by the PPR tracking circuitry.

9. The memory device of claim 7, wherein executing the command further comprises:
causing the sPPR circuitry to reversibly latch a fuse element in the PPR fuse array if the received input from the PPR tracking circuitry determines that the fuse element of the PPR fuse array has not been latched; and
blowing an associated tracking fuse bit readable by the PPR tracking circuitry.

10. A system comprising:
host device; and
a memory device, having memory arrays and control logic, coupled to the host device to receive commands, the control logic, comprising:
command decode logic;
a mode register coupled to the command decode logic;
post-packaging repair (PPR) circuitry coupled to the mode register; and
PPR tracking circuitry coupled to the mode register and the PPR circuitry; and
a post packaging repair (PPR) fuse array connected to the control logic within the memory device, wherein the control logic configured to:
receive a command from the mode register to program the PPR fuse array;
receive input from the PPR tracking circuitry to identify whether the command to program the PPR fuse array has already been executed; and
execute the command based on the received input from the PPR tracking circuitry.

11. The system of claim 10, wherein the memory device is a DRAM.

12. The system of claim 10, wherein the PPR circuitry includes a hard post-packaging repair (hPPR) circuit and a soft post-packaging repair (sPPR) circuit.

13. The system of claim 10, wherein the PPR tracking circuitry is configured to determine whether a fuse of the PPR fuse array has been blown or reversibly latched.

14. The system of claim 13, wherein the PPR circuitry blows a fuse upon determining that the fuse of the PPR fuse array has not been blown.

15. The system of claim 13, wherein the PPR circuitry latches a fuse element upon determining that the fuse element of the PPR fuse array has not been latched.

16. The system of claim 13, wherein the PPR circuitry executes the command to blow a fuse or latch a fuse element in the PPR fuse array to substitute a redundant row in a memory array of the memory device.

17. The system of claim 16, wherein the PPR circuitry blows a standard fuse and blows an additional tracking fuse bit in a tracking fuse bit array in a hard PPR (hPPR) sequence.

18. The system of claim 16, wherein the PPR circuitry latches a standard fuse element and blows an additional tracking fuse bit in a tracking fuse bit array in a soft PPR (sPPR) sequence.

19. A memory device, comprising:
a memory array;
control logic coupled to the memory array, the control logic to receive memory device commands, the control logic, comprising:
command decode logic;
a mode register coupled to the command decode logic;
post-packaging repair (PPR) circuitry coupled to the mode register; and
PPR tracking circuitry coupled to the mode register and the PPR circuitry; and
a plurality of post package repair (PPR) latches programmable as part of a PPR sequence, wherein the control logic configured to:
receive a PPR command to set PPR latches from the mode register;
receive input from the PPR tracking circuitry to identify whether the command to set the PPR latches has already been executed; and
execute the command based on the received input from the PPR tracking circuitry.

20. The memory device of claim 19, wherein a state of the PPR latches is reversible.

21. The memory device of claim 20, wherein the PPR circuitry latches a fuse element when received input from the tracking circuitry determines the PPR command has not been previously received.

22. The memory device of claim 21, wherein latching the fuse element substitutes a redundant row in the memory array.

23. The memory device of claim 22, wherein the PPR circuitry additionally blows an associated tracking fuse bit in a tracking fuse bit array upon latching the fuse element.

24. The memory device of claim 23, wherein the PPR circuitry stores information for the blown associated tracking fuse bit in a PPR register associated with the control logic.

25. The memory device of claim 19, wherein the PPR circuitry is further configured to:
receive a hard PPR (hPPR) command to blow a fuse in a PPR fuse array when received input from the tracking circuitry determines the hPPR command has not been previously received; and
blow an associated tracking fuse bit in a tracking fuse array upon blowing the fuse in the PPR fuse array.
